(19) United States
(12) Patent Application Publication
(10) Pub. No.: US 2009/0291344 A1
(43) Pub. Date: Nov. 26, 2009

(54) FUEL CELL

(75) Inventors: Takumi Tanaka, Aichi-ken (JP); Tsuguhiro Fujita, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, AICHI-KEN (JP)

(21) Appl. No.: 12/375,690

(22) PCT Filed: Jul. 30, 2007
(86) PCT No.: PCT/IB07/02168

§ 371 Date: Jan. 30, 2009

(30) Foreign Application Priority Data
Jul. 31, 2006 (JP) 2006-207595

(51) Int. Cl. H01M 8/10

(52) U.S. Cl. 429/30

(57) ABSTRACT

On an anode side separator, an adhesive is applied linearly along the upper and lower edges of the four edges thereof, around a receiving part and around a through-hole and so on. On a cathode side separator, the adhesive is applied at the same locations as on the anode side separator. The adhesive functions as support members for supporting the fastening load on the edges of the separators.

### BACKGROUND OF THE INVENTION

1. Field of the Invention

The present invention relates to a fuel cell, and more particularly, to a fuel cell having a stack structure in which a plurality of unit cells are stacked on top of one another.

2. Description of the Related Art

A fuel cell stack has a stack of unit cells each having an electrolyte membrane, a pair of electrodes disposed on both sides of the electrolyte membrane, and a pair of separators disposed outside the electrodes. In such a fuel cell stack, a fuel gas is supplied to the anode of each unit cell through a fuel gas supply manifold. Similarly, an oxidant gas is supplied to the cathode of each unit cell through an oxidant gas supply manifold. The manifolds extend in the stacking direction through the fuel cell stack. Each separator has an outer peripheral portion through which through-holes are formed, and the through-holes define the manifolds when the unit cells are stacked on top of one another. In such a unit cell, a seal member is often interposed between the paired separators to prevent leakage of the fuel gas and oxidant gas. For example, Japanese Patent Application Publication No. 2003-223903 (JP-A-2003-223903) discloses a unit cell having seal members provided around through-holes of separators and around a power generating part thereof.

In such a fuel cell stack, a fastening load may be applied in the stacking direction of the fuel cell stack to improve the sealability of the seal members and to prevent deterioration of cell function due to poor electrical contact in the fuel cell stack. For example, a fastening load can be applied in the stacking direction of the fuel cell stack by providing end plates at both ends of the stack and fastening nuts threaded on tension rods extending through the four corners of the end plates.

FIG. 7A shows a plan view of an example of a separator for a fuel cell stack according to a related art, and FIG. 7B shows a cross-sectional view of the fuel cell stack taken along the line VII-VII of FIG. 7A.

As shown in FIG. 7A, the separator 41 has an outer peripheral portion having a through-hole 416i and so on for allowing a fuel gas, an oxidant gas, and a cooling medium to flow therethrough, and seal members S provided around the through-holes and around a power generating part. In FIG. 7A, the seal members S are indicated by oblique hatching. For example, suppose that the seal lines of the seal members S pressing the separators from both sides are misaligned relative to each other in the fuel cell stack because of misalignment during stacking of the unit cells each having an MEA 48 sandwiched between the separators 41. In this case, when the cross-sectional view of the fuel cell stack taken along the line VII-VII of FIG. 7A is viewed, the seal members S are located above the MEAs 48 as shown in FIG. 7B. As described above, since the seal lines of the seal members S pressing the separators from both sides are misaligned relative to each other, pressures as indicated by arrows in FIG. 7B are applied and bending stress is exerted on the separators. Thus, in the case of metal separators, the separators may be bent until the edges of the separators come into contact with each other as shown by broken lines in FIG. 7B to cause an electrical short circuit. In the case of carbon separators, when the seal lines of the seal members S are misaligned relative to each other, the separators may develop cracks at locations where the seal members apply pressures.

### DISCLOSURE OF THE INVENTION

The present invention provides an fuel cell separators having edges that are not deformed or broken by a fastening load in the stacking direction.

A first aspect of the present invention relates to a fuel cell. The fuel cell has a stack of unit cells each having an electrolyte membrane, a pair of electrodes disposed on both sides of the electrolyte membrane, and a pair of separators disposed outside the paired electrodes. In the fuel cell, a fastening load is applied in the stacking direction to maintain the stacked state of the stack. The fuel cell has through-holes formed through outer peripheral portions of the separators that allow at least a reactant gas to flow through the separators; and support members disposed between the pairs of separators for supporting the fastening load in areas with no through-holes on the outer peripheral portions of the separators.

The fuel cell described above may further include seal members formed along at least part of the edges of the through-holes. The support members may be formed integrally with the seal members.

In the fuel cell, the support members are located in areas with no through-holes on the outer peripheral portions of the separators. The fuel cell has seal members provided around the through-holes, through which a reactant gas flows, and the seal members also support separators between the separators. When the positions of the seal members are shifted when the separators are pressed from both sides, bending stress is exerted on the separators. In the fuel cell according to the first aspect of the present invention, the separators are less likely to be bent because the edges of the separators are supported by the support members. Therefore, in the case of metal separators, the separators do not bent until the edges of the separators come into contact with each other to cause an electrical short circuit. In the case of carbon separators, the separators may be prevented from developing cracks at locations where the seal members are misaligned relative to each other.

The seal members may be implemented in various forms such as seal gaskets, seal gasket-integrated MEAs, and adhesive seals. The seal members may be formed around the through-holes, or the seal member may be omitted at positions where the through holes are communicated with reaction gas passages. By providing seal members as described above the flow of reactant gas is not interfered with.

In the fuel cell according to the first aspect of the present invention, because the support members are formed integrally with the seal members, the number of parts can be reduced and the assembly of the fuel cell stack can be facilitated.

In the fuel cell according to the first aspect of the present invention, the pairs of separators, the seal members and the support members do not form an enclosed space.

Here, the enclosed space have no openings for communication with other spaces. For example, it can be thought of a case where, when closed regions (for example, rectangular regions) are formed by the seal members formed around the through-holes and the support members formed integrally with the seal members, closed spaces are formed by the separators, the support members and the seal members when the support members are disposed between the pairs of separators.

In the fuel cell according to the first aspect of the present invention, the pairs of separators, the seal members and the support members do not form an enclosed space. Therefore, the following effect is achieved. For example, when closed spaces are formed by the separators, support members, and seal members, the air in the closed spaces may expand because of self heating and flow beyond the seal members and support member to the side of the through-holes while the fuel cell is operating. Then, the sealability of the seal members formed around the through-holes deteriorates and the reactant gas flows through the through-holes and may leak to the outside. However, according to the fuel cell of the present invention, because a closed space is not formed, the force which causes gas to move beyond the seal members formed around the through-holes is not generated. Therefore, deterioration of sealability is prevented.

The support members may be adhesives.

The adhesive may be a silicone, epoxy resin, epoxy-modified silicone, olefin, or olefin-modified silicone.

The support members may be seal gaskets.

The support members may have gas impermeability, elasticity, and heat resistance.

In the fuel cell according to the first aspect of the present invention, because the support members comprise an adhesive, each of the unit cells is integrated into a unitary body. Therefore, when a plurality of unit cells are stacked, the fuel cell stack may be easily assembled with high accuracy as compared to the case where the separators, electrodes, electrolyte membranes and so on are stacked individually.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a perspective view illustrating the general configuration of a fuel cell stack 100 according to a first embodiment of the present invention;

FIGS. 2A and 2B are plan views of separators 41a and 47a, respectively, of the first embodiment, and FIG. 2C is a cross-sectional view of a unit cell 40a of the first embodiment;

FIG. 3 is a cross-sectional view of the fuel cell stack 100 according to the first embodiment;

FIGS. 4A and 4B are plan views of separators 41b and 47b, respectively, according to a second embodiment, and FIG. 4C is a cross-sectional view of a unit cell 40b of the second embodiment;

FIGS. 5A and 5B are plan views of separators 41c and 47c, respectively, according a third embodiment, and FIG. 5C is a cross-sectional view of a unit cell 40c of the third embodiment;

FIG. 6A is a plan view of a seal gasket-integrated MEA 489 according to a fourth embodiment, and FIG. 6B is a cross-sectional view of a unit cell 40d of the fourth embodiment; and

FIG. 7A is a plan view of a separator 41 for a fuel cell according to the related art, and FIG. 7B is a cross-sectional view of the fuel cell.

### DETAILED DESCRIPTION OF EXAMPLE EMBODIMENTS

The best mode for carrying out the present invention is described in the following order: A First embodiment, B. Second embodiment, C. Third embodiment, D. Fourth embodiment, E. Modification.

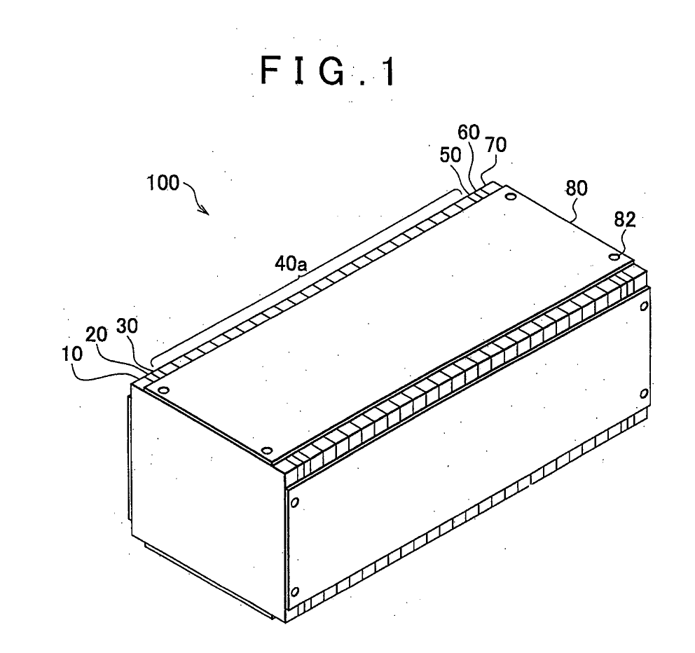

A. First embodiment: A1. Configuration of fuel cell stack: FIG. 1 is a perspective view illustrating the general configuration of a fuel cell stack 100 according to a first embodiment of the present invention. The fuel cell stack 100 produces an electromotive force by an electrochemical reaction between hydrogen as a fuel gas and oxygen in air as an oxidant gas at each electrode. As illustrated, the fuel cell stack 100 is formed by stacking a prescribed number of unit cells 40a on top of one another. The number of the unit cells 40a may be arbitrarily determined based on the output power required from the fuel cell stack 100. In this embodiment, each unit cell 40a is a polymer electrolyte fuel cell.

In the fuel cell stack 100, an end plate 10, an insulating plate 20, a current collecting plate 30, a plurality of unit cells 40a, a current collecting plate 50, an insulating plate 60, and an end plate 70 are stacked in the stated order from one end to the other. These members have supply ports, discharge ports, and passages (not shown) to allow hydrogen as fuel gas, air as oxidant gas, and coolant to flow through the fuel cell stack 100. The hydrogen is supplied from a hydrogen tank (not shown). The air and the coolant are pressurized and supplied by pumps (not shown). A coolant separator (not shown) each having a coolant passage through which coolant flows is interposed between every five unit cells 40a.

The fuel cell stack 100 has tension plates 80. In the fuel cell stack 100, a pressure is applied in the stacking direction of the stack structure. As a result, deterioration of cell performance due to poor electrical contact in the fuel cell stack 100 can be prevented and the sealing performance of seal members is ensured. The tension plates 80 are secured to the end plates 10 and 70 at both ends of the fuel cell stack 100 by bolts 82 in the fuel cell stack 100. As a result, the unit cells 40a are fastened by a prescribed fastening force in the stacking direction.

The end plates 10 and 70, and the tension plates 80 are made of a metal, such as steel, to ensure rigidity. The insulating plates 20 and 60 are made of an insulating material such as rubber or resin. The current collecting plates 30 and 50 are made of a gas-impermeable conductive material such as dense carbon or copper plate. Each of the current collecting plates 30 and 50 has an output terminal (not shown) so that the electric power generated in the fuel cell stack 100 may be output.

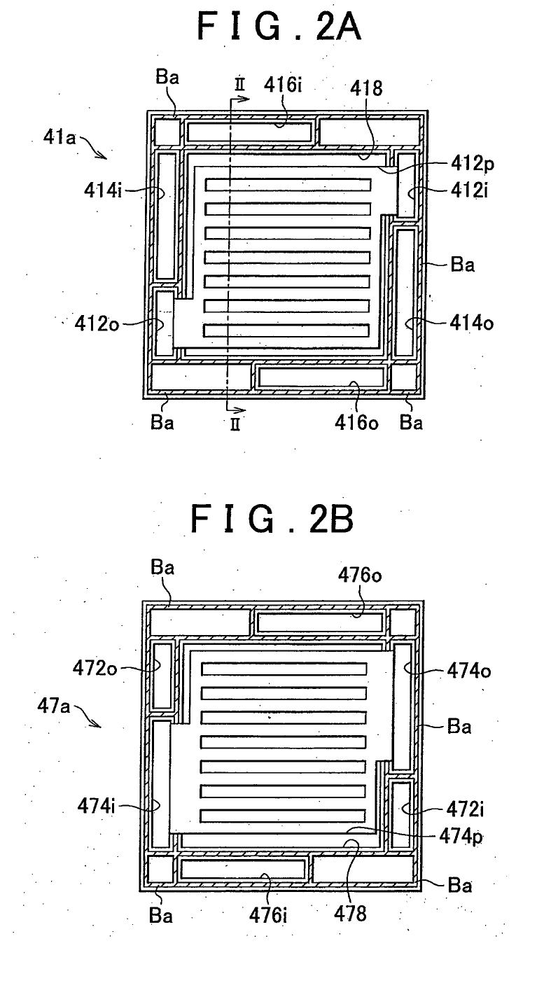

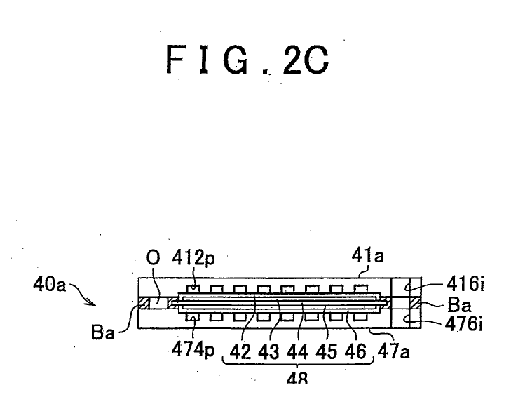

Next the unit cell 40a will be described with reference to FIG. 2A to FIG. 2C. FIG. 2A is a plan view illustrating the face of an anode side separator 41a that contacts an anode side diffusion layer 42. As illustrated, the anode side separator 41a is a flat plate having a generally square planar shape. The anode side separator 41a has an outer peripheral portion through which a hydrogen supply through-hole 412i, a hydrogen discharge through-hole 412o, an air supply through-hole 414i, an air discharge through-hole 414o, a coolant supply through-hole 416i, and a coolant discharge through-hole 416o, each of which is a through-hole having a generally rectangular planar shape, are formed. The anode side separator 41a also has a receiving part 418 as a recess with a generally square planar shape into which a membrane electrode assembly (which is hereinafter also referred to simply as “MEA”) 48 shown in FIG. 2C is fitted. The anode side separator 41a also has groove-like hydrogen passages 412p communicated with the hydrogen supply through-hole 412i and the hydrogen discharge through-hole 412o.

FIG. 2B is a plan view that illustrates the face of a cathode side separator 47a that contacts a cathode side diffusion layer 46. As illustrated, the cathode side separator 47a is also a flat plate having a generally square planar shape similar to that of the above anode side separator. The cathode side separator 47a has an outer peripheral portion through which a hydrogen supply through-hole 472i, a hydrogen discharge through-hole 472o, an air supply through-hole 474i, an air discharge through-hole 474o, a coolant supply through-hole 476i, and a coolant discharge through-hole 476o, each of which is a through-hole having a generally rectangular planar shape, are formed. As in the case of the above anode side separator 41a, the cathode side separator 47a has a receiving part 478 having a generally square planar shape, and groove-like air passages 474p communicated with the air supply through-hole 474i and the air discharge through-hole 474o. Although flat plates of stainless steel are used for the separators 41a and 47a in this embodiment, flat plates of other metals such as titanium or aluminum or flat plates of carbon may be used instead.

FIG. 2C is a cross-sectional view of the unit cell 40a taken along the line II-II of FIG. 2A. An anode side diffusion layer 42, an anode 43, an electrolyte membrane 44, a cathode 45, and a cathode side diffusion layer 46 are stacked in this order to form an MEA 48. A unit cell 40a is formed by interposing an MEA 48 between an anode side separator 41a disposed on the anode side diffusion layer 42 side and a cathode side separator 47a disposed on the cathode side diffusion layer 46 side. In this embodiment, a polyelectrolyte membrane made of a fluororesin is used as the electrolyte membrane 44. As the anode 43 and the cathode 45, catalyst electrodes of carbon cloth supporting platinum and a platinum alloy as catalysts are used. For the diffusion layers 42 and 46, carbon porous bodies are used. When such diffusion layers 42 and 46 are used, the gases can be dispersed and supplied onto the entire surfaces of the anode 43 and the cathode 45 efficiently. For the electrolyte membrane, other electrolytes such as a solid oxide may be used. The electrodes may be formed from carbon paper or carbon felt made of carbon fibers.

The unit cell 40a is integrated into a unitary body by an adhesive Ba applied on the anode side separator 41a and the cathode side separator 47a. The lines of adhesive Ba (areas indicated by oblique hatching) are described below with reference to FIG. 2A to FIG. 2C. For the adhesive Ba, a material such as silicone, epoxy resin, epoxy-modified silicone, olefin, or olefin-modified silicone may be used. On the anode side separator 41a, the adhesive Ba is applied continuously along all four edges thereof as shown in FIG. 2A. The adhesive Ba is also applied around the receiving part 418, into which the MEA 48 is adapted to be fitted, and around the through-holes 412i, 412o, 414i, 414o, 416i and 416o. The adhesive Ba is not applied in the areas where the hydrogen passages are formed in the regions around the hydrogen supply through-hole 412i and the hydrogen discharge through-hole 412o, so as not to interfere with inflow and outflow of hydrogen.

Similarly, on the cathode side separator 47a, the adhesive Ba is applied continuously along all four edges thereof as shown in FIG. 2B. The adhesive Ba is also applied around the receiving part 478, into which the MEA 48 is adapted to be fitted, and around the through-holes 472i, 472o, 474i, 474o, 476i and 476o. The adhesive Ba is not applied in the areas where the air passages are formed in the regions around the air supply through-hole 474i and the air discharge through-hole 474o so as not to interfere with inflow and outflow of air.

The lower edge of the anode side separator 41a and the upper edge of the cathode side separator 47a are bonded to each other as shown in FIGS. 2A and 2B. The upper edge of the anode side separator 41a and the lower edge of the cathode side separator 47a are bonded to each other as shown in FIGS. 2A and 2B. When a pressurizing load is applied to the anode side separator 41a and the cathode side separator 47a with an MEA 48 interposed the separators and the adhesive Ba is cured, an integrated unit cell 40a is formed. Then, the adhesive Ba applied around the receiving parts 418 and 478 and around the through-holes functions as a seal member that prevents leakage of hydrogen, air and coolant. The adhesive Ba, which is applied continuously along all four edges of the separators 41a and 47a, functions as a support member for supporting the fastening load described before on the edges of the separators. Because a pressurizing load is applied when the adhesive Ba is cured, the adhesive Ba is spread to the edges of the separators 41a and 47a as shown in FIG. 2C. In this embodiment, the adhesive Ba may be regarded as a seal member and a support member. The effect of this is described in detail later.

When a plurality of unit cells 40a constituted as described above are stacked on top of each other to form a fuel cell stack 100, the hydrogen supply through-holes 412i and 472i form a hydrogen supply manifold (not shown) extending through the fuel cell stack 100 in the stacking direction. Similarly, the hydrogen discharge through-holes 412o and 472o form a hydrogen discharge manifold (not shown), the air supply through-holes 414i and 474i form an air supply manifold (not shown), the air discharge through-holes 414o and 474o form an air discharge manifold (not shown), the coolant supply through-holes 416i and 476i form a coolant supply manifold (not shown), and the coolant discharge through-holes 416o and 476o form a coolant discharge manifold (not shown). Hydrogen supplied from the hydrogen tank (not shown) to the fuel cell stack 100 is distributed into the hydrogen passages 412p of the unit cells 40a through the hydrogen supply manifold and supplied to the anodes 43. Hydrogen that is not consumed in the electrode reaction is discharged from the fuel cell stack 100 through the hydrogen discharge manifold. Similarly, air from the atmosphere outside the fuel cell stack 100 pressurized and supplied to the fuel cell stack 100 by a pump (not shown) is distributed through the air passages 474p of the unit cells 40a through the air supply manifold and supplied to the cathodes 45. Air that is not consumed in the electrode reaction is discharged from the fuel cell stack 100 through the air discharge manifold. Coolant supplied to the fuel cell stack 100 is distributed to a plurality of coolant separators through the coolant supply manifold and flows through the coolant passages therein to cool the unit cells. After that, the coolant is discharged from the fuel cell stack 100 through the coolant discharge manifold.

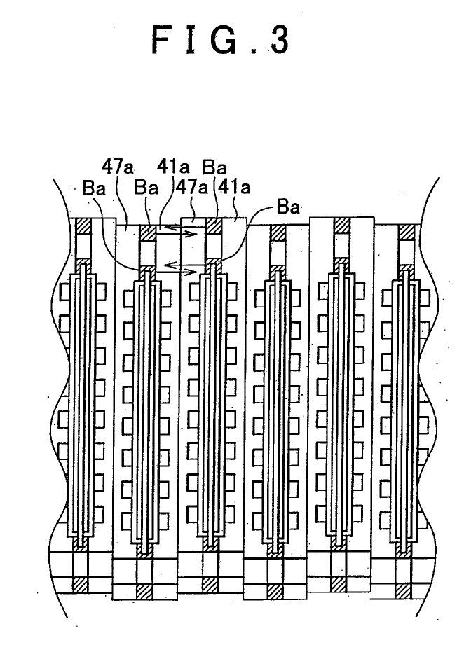

A2. Effect: The effect of the fuel cell stack 100 according to this embodiment is described below with reference to FIG. 3. FIG. 3 is a cross-sectional view of the unit cell stack 100 taken along the line II-II of FIG. 2A. In FIG. 3, the pressures applied to the some of the plurality of separators 41a and 47a are indicated by arrows and the others are omitted.

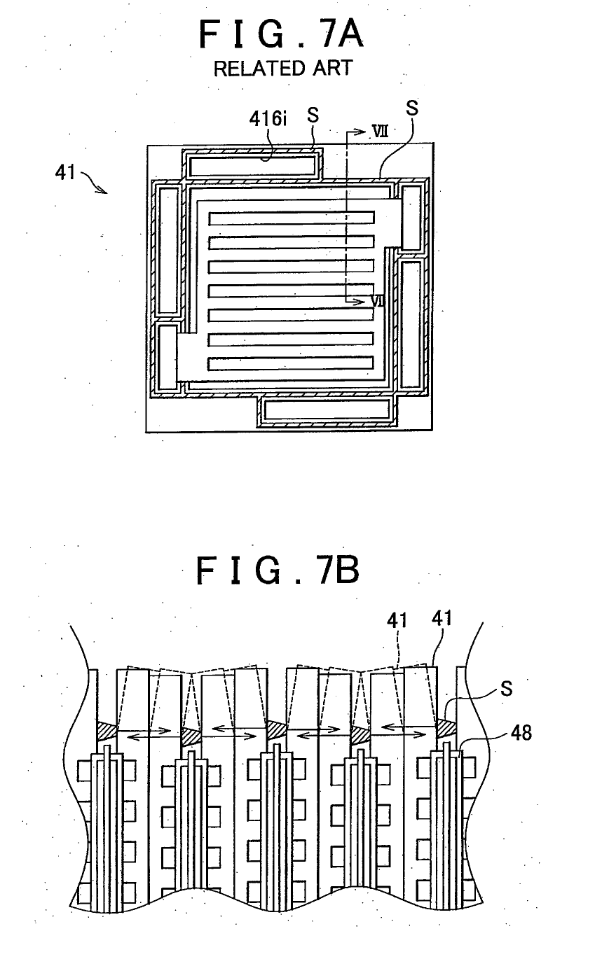

In the fuel cell stack of the related art, when the load points where pressures are applied to the separators from both sides in areas with no through-holes on the outer peripheral portions of the separators are displaced relative to each other, bending stress is exerted on the separators and the separators may be bent (FIG. 7B). In the fuel cell stack 100 of this embodiment, however, the adhesive Ba is applied continuously along all four sides of the cathode side separator 41a and the anode side separator 47a. That is, as shown in FIG. 3, the parts of the edges with no through-holes (upper parts in FIG. 3) of the separators 41a and 47a are supported by the adhesive Ba. Thus, even if the positions of the adhesive Ba pressing the separators 41a and 47a from both sides are displaced relative to one another because of misalignment of the unit cells 40a during stacking, the separators are not bent because the edges of the separators 41a and 47a are supported. Therefore, deformation in the outer peripheral portions of the separators may be prevented.

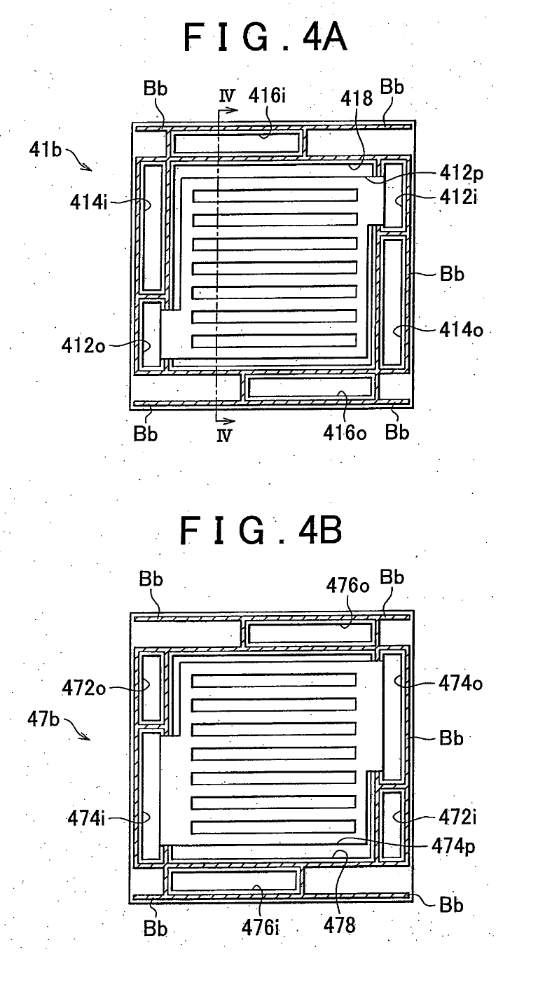

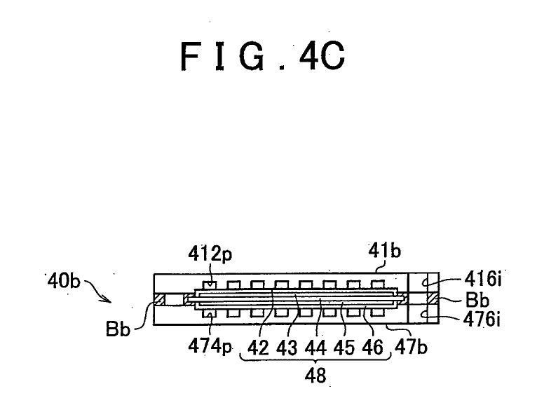

B. Second embodiment: B1. Configuration of fuel cell stack: The configuration of a fuel cell stack of a second embodiment is similar to that of the fuel cell stack 100 of the first embodiment with the exception of the lines of adhesive Bb in unit cells 40b and hence description of similar features will not repeated. The lines of adhesive Bb (areas indicated by oblique hatching in FIG. 4A to FIG. 4C) in a unit cell 40b of this embodiment are described below with reference to FIG. 4A to FIG. 4C.

FIG. 4A is a plan view illustrating the face of an anode side separator 41b that contacts an anode side diffusion layer 42. On the anode side separator 41b, the adhesive Bb is applied linearly along two edges through which the coolant supply through-hole 416i and the coolant discharge through-hole 416o are formed (upper and lower edges) of the four edges thereof, around the receiving part 418, into which the MEA 48 is adapted to be fitted, and around the through-holes 412i, 412o, 414i, 414o, 416i, and 416o as shown in FIG. 4A. The adhesive Bb is not applied in the areas where the hydrogen passages 412p are formed in the regions around the hydrogen supply through-hole 412i and the hydrogen discharge through-hole 412o so as not to interfere with inflow and outflow of hydrogen.

FIG. 4B is a plan view illustrating the face of a cathode side separator 47b that contacts the cathode side diffusion layer 46. On the cathode side separator 47b, the adhesive Bb is applied linearly along two edges through which the coolant discharge through-hole 476o and the coolant supply through-hole 476i are formed (upper and lower edges) of the four edges thereof, around the receiving part 418, into which the MEA 48 is fitted, and around the through-holes 472i, 472o, 474i, 474o, 476i, and 476o as shown in FIG. 4B. The adhesive Bb is not applied in the areas where the air passages 474p are formed in the regions around the air supply through-hole 474i and the air discharge through-hole 474o so as not to interfere with inflow and outflow of air.

As in the case of the first embodiment, when a pressurizing load is applied to the anode side separator 41b and the cathode side separator 47b with an MEA 48 interposed therebetween so that the lower edge of the anode side separator 41b and the upper edge of the cathode side separator 47b are bonded to each other and the upper edge of the anode side separator 41b and the lower edge of the cathode side separator 47b are bonded to each other as shown in FIG. 4A and FIG. 4B and the adhesive Bb is cured, an integrated unit cell 40b is formed (FIG. 4C). Then, the adhesive Bb applied around the receiving parts 418 and 478 and around the through-holes functions as a seal member for preventing leakage of hydrogen, air, and coolant. The adhesive Bb applied linearly along the upper and lower edges of the separators 41b and 47b functions as a support member for supporting the fastening load described before on the edges of the separators. Because a pressurizing load is applied when the adhesive Bb is cured, the adhesive Bb is spread to the very edges of the separators 41a and 47a as shown in FIG. 4C. In this embodiment, the adhesive Bb can be regarded as a seal member and a support member.

B2. Effect: In the fuel cell stack of this embodiment, the adhesive Bb is applied along the upper and lower edges of the separators 41b and 47b in the areas with no through-holes on the outer peripheral portions of the separators 41b and 47b. Thus, even if the lines of adhesive Bb pressing the separators 41b and 47b from both sides are displaced relative to each other in the areas with no through-holes, the separators are not bent because the edges of the separators 41b and 47b are supported by the adhesive Bb as in the first embodiment. Therefore, deformation in the outer peripheral portions of the separators may be prevented.

When the adhesive Bb is applied as in the first embodiment, for example, closed regions surrounded by the lines of adhesive Bb are formed at the corners of the separators 41b and 47b. Then, when the anode side separator 41b and the cathode side separator 47b are bonded to each other to form an integrated unit cell 40b, closed spaces (indicated as O in FIG. 2C) are formed. Because the anode side separator 41b and the cathode side separator 47b are bonded to each other by applying a pressure to form a unit cell 40b, the air in the closed spaces may break the lines of adhesive Bb and flow toward the through-holes because of the pressure. Also, when the air in the closed spaces expands or contracts because of changes in temperature with the start or stop of operation of the fuel cell stack, the air in the closed spaces may flow toward the through-holes or hydrogen or air may flow from the through-holes into the closed spaces. In other words, when the air in the closed spaces expands or contracts, the parts bonded by the adhesive Bb may be separated and the function of the adhesive Bb as seal members may be impaired.

However, in the fuel cell of this embodiment, the adhesive Bb applied along the upper and lower edges of the anode side separator 41b and the adhesive Bb applied around the through-holes 412i, 412o, 414i, and 414o are not connected to each other. Similarly, the adhesive Bb applied along the upper and lower edges of the cathode side separator 47b and the adhesive Bb applied around the through-holes 472i, 472o, 474i and 474o are not connected to each other. That is, the adhesive Bb, which functions as a support member, and the adhesive Bb, which functions as a seal member, do not form a closed region. Thus, when an anode side separator 41b and a cathode side separator 47b are bonded to each other to form an integrated unit cell 40b, any closed space containing air is not formed in the unit cell 40b. Therefore, the adhesive Bb applied around the through-holes can be prevented from being broken and its function as seal members cannot be impaired.

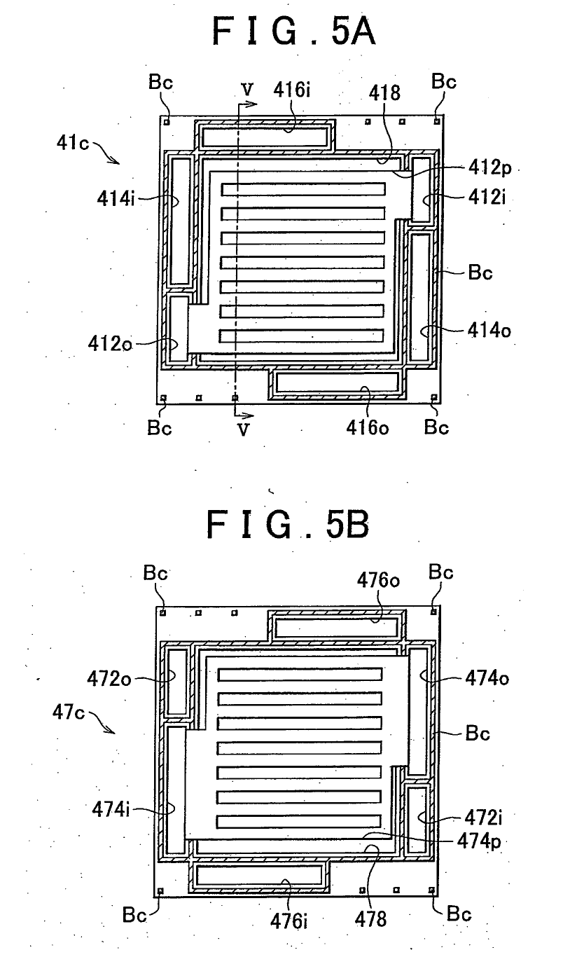

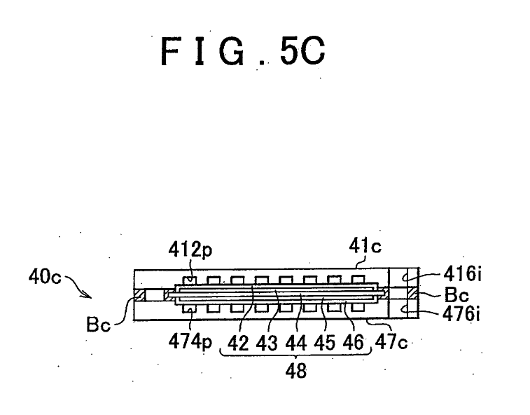

C. Third embodiment: C1. Configuration of fuel cell stack: The configuration of a fuel cell stack according to a third embodiment is similar to that of the fuel cell stack 100 of the first embodiment with the exception of the lines of adhesive Bc in unit cells 40c and hence description of the similar features will not be repeated. The lines of adhesive Bc (areas indicated by oblique hatching in FIG. 5) in a unit cell 40c of this embodiment are described below with reference to FIG. 5.

FIG. 5A is a plan view illustrating the face of an anode side separator 41c that contacts an anode side diffusion layer 42. On the anode side separator 41c, the adhesive Bc is applied around the receiving part 418 and around the through-holes 412i, 412o, 414i, 414o, 416i, and 416o as shown in FIG. 5A. In addition, the adhesive Bc is applied in spots along the upper and lower edges of the anode side separator 41c.

FIG. 5B is a plan view illustrating the face of a cathode side separator 47c that contacts a cathode side diffusion layer 46. On the cathode side separator 47c, the adhesive Bc is applied around the receiving part 478 and around the through-holes 472i, 472o, 474i, 474o, 476i, and 476o as shown in FIG. 5B. In addition, the adhesive Bc is applied in spots along the upper and lower edges of the cathode side separator 47c. The adhesive Bc is not applied in the areas in which the hydrogen passages 412p are formed in the regions around the hydrogen supply through-hole 412i and the hydrogen discharge through-hole 412o and in the areas in which the air passages 474p are formed in the regions around the air supply through-hole 474i and the air discharge through-hole 474o, so as not to interfere with inflow and outflow of hydrogen and air as in the first embodiment.

The lower edge of the anode side separator 41c and the upper edge of the cathode side separator 47c are bonded to each other as in the first embodiment as shown in FIGS. 5A and 5B. The upper edge of the anode side separator 41c and the lower edge of the cathode side separator 47c are bonded to each other as shown in FIGS. 5A and 5B. When a pressurizing load is applied to the anode side separator 41c and the cathode side separator 47c with an MEA 48 interposed the separators and the adhesive Bc is cured, an integrated unit cell 40c is formed (FIG. 5C). Then, the adhesive Bc applied around the receiving parts 418 and 478 and around the through-holes functions as a seal member for preventing leakage of hydrogen, air and coolant. The adhesive Bc applied in spots along the upper and lower edges of the separators 41c and 47c functions as a support member for supporting the fastening load described before on the edges of the separators. In this embodiment, the adhesive Bc may be regarded as seal members and support members as described above.

C2. Effect: In the fuel cell stack of this embodiment, the adhesive Bc is applied in spots along the upper and lower edges of the separators 41c and 47c to the areas with no through-holes on the outer peripheral portion of the separators 41c and 47c. Thus, even if the lines of adhesive Bc pressing the separators 41c and 47c from both sides are displaced relative to each other in the areas with no through-holes, the separators are not bent because the edges of the separators 41c and 47c are supported by the adhesive Bc as in the first embodiment. Therefore, deformation in the outer peripheral portions of the separators may be prevented.

In addition, in the fuel cell stack of this embodiment, the adhesive Bc which functions as a seal member and the adhesive Bc which functions as a support member for supporting the fastening load exerted on the separators do not form any closed region. Thus, when the anode side separator 41c and the cathode side separator 47c are bonded to each other to form an integrated unit cell 40c, any closed space containing air is not formed in the unit cell 40c as in the second embodiment. Therefore, the adhesive Bc applied around the through-holes may be prevented from being broken and its function as a seal member is not impaired.

In addition, in the fuel cell stack of this embodiment, because the adhesive Bc is applied in spots on the anode side separator 41c and the cathode side separator 47c except for the areas around the receiving part 418 and around the through-holes, the amount of the adhesive Bc can be reduced. Therefore, the cost and weight of the fuel cell stack can be decreased.

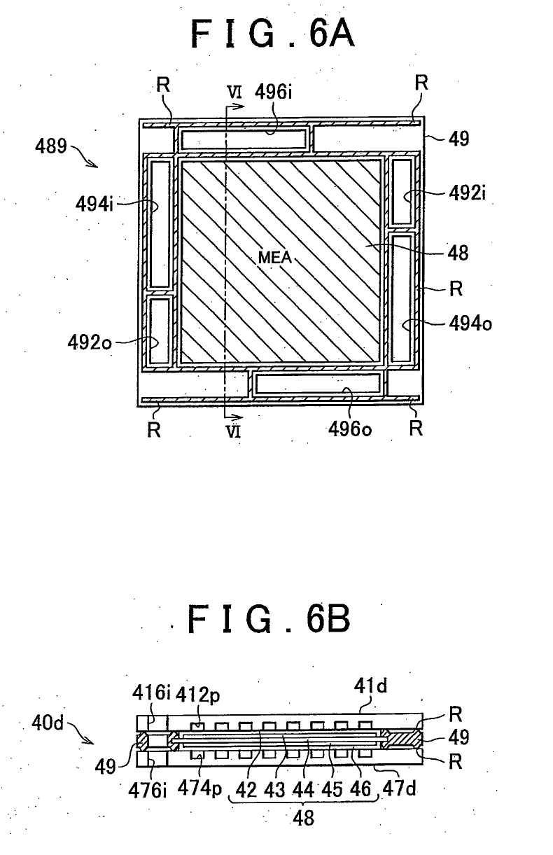

D. Fourth embodiment: D1. Configuration of fuel cell stack: The configuration of a fuel cell stack of a fourth embodiment is similar to that of the fuel cell stack 100 of the first embodiment with the exception of the configuration of unit cells 40d and hence description of similar features will not repeated. The configuration of the unit cell 40d in this embodiment is described below with reference to FIG. 6. In FIG. 6, ribs R formed on a seal gasket 49 are indicated by oblique hatching.

FIG. 6A is a plan view illustrating the face of a seal gasket-integrated MEA 489 that contacts an anode side separator 41d, and FIG. 6B is a cross-sectional view of the unit cell 40d taken along the line VI-VI of FIG. 6A. A seal gasket 49 is formed around the MEA 48 having a generally square planar shape to surround an electrolyte membrane 44 of the MEA 48 as shown in FIG. 6A The seal gasket 49 has a hydrogen supply through-hole 492i, a hydrogen discharge through-hole 492o, an air supply through-hole 494i, an air discharge through-hole 494o, a coolant supply through-hole 496i, and a coolant discharge through-hole 496o, each of which is a through-hole having a generally rectangular planar shape. The seal gasket 49 has raised ribs R formed integrally therewith around the through-holes and the MEA 48. The seal gasket 49 also has linear ribs R formed integrally therewith along the upper and lower edges thereof. The ribs R formed around the through-holes and around the MEA 48 function as seal members for preventing leakage of hydrogen, air, and coolant, and the ribs R formed along the upper and lower edges of the seal gasket 49 function as support members for supporting the fastening load described before. The effect of this is described in detail later. Although silicone rubber is used for the seal gasket 49 in this embodiment, the present invention is not limited thereto and other materials having gas impermeability, elasticity and heat resistance may be used instead. In this embodiment, the ribs R may be regarded as seal members and support members as described above.

The anode side separator 41d is a flat plate having a generally square planar shape and has the same through-holes as those of the seal gasket 49 through the outer peripheral portion thereof as in the case of the anode side separator 41a of the first embodiment. The anode side separator 41d also has groove-like hydrogen passages 412p (FIG. 6B) communicated with the hydrogen supply through-hole and the hydrogen discharge through-hole. Similarly, the cathode side separator 47d is a flat plate having a generally square planar shape and has the same through-holes as those of the seal gasket 49 through the outer peripheral portion thereof as in the case of the cathode side separator 47a of the first embodiment. The anode side separator 41d also has groove-like air passages 747p (FIG. 6B) communicated with the air supply through-hole and the air discharge through-hole. Although flat plates of carbon are used for the anode side separator 41d and the cathode side separator 47d in this embodiment, the present invention is not limited thereto and flat plate of a metal such as stainless steel, titanium or aluminum may be used instead.

A unit cell 40d is formed by interposing a seal gasket-integrated MEA 489 between an anode side separator 41d and a cathode side separator 47d as shown in FIG. 6B. When a plurality of unit cells 40d are stacked on top of one another, the through-holes of the separators 41d and 47d and the seal gasket-integrated MEAs 489 form manifolds extending through the fuel cell stack 100 in the stacking direction. Then, as in the first embodiment, hydrogen as a fuel gas, air as an oxidant gas, and coolant as a cooling medium are supplied to the fuel cell stack through the manifolds.

D2. Effect: The seal gasket-integrated MEA of the fuel cell stack according to the related art has ribs formed around the MEA and around the through-holes. When a fuel cell stack is formed, the separators are pressed from both sides by the ribs. The positions of the ribs located on both sides of the separators may be shifted relative to each other when the unit cells are stacked, and the ribs may be deformed by gas pressure while the fuel cell stack is operating. Then, the load points where pressures are applied to the separators from both sides may be displaced relative to each other. When the load points where pressures are applied to the separators from both sides are displaced relative to each other, bending stress is exerted on the separators. This may cause cracks to develop in carbon separators.

In the fuel cell stack of this embodiment, however, linear ribs R are formed along the upper and lower edges of the seal gasket 49. Thus, even if the ribs R pressing the separators 41d and 47d from both sides are misaligned relative to each other, the separators are not bent because the edges of the separators are supported by the ribs R which function as support members. Therefore, cracks in the outer peripheral portions of the separators are prevented from forming.

E. Modification: Although an example in which an adhesive is used as support members is shown in the first and second embodiments described above, a seal gasket may be used instead. Although an example in which an adhesive is applied in spots as support members is shown in the third embodiment, spherical or columnar members may be used instead.

Although an example in which each separator has support members extending continuously along all four edges thereof (first embodiment), an example in which each separator has support members extending along two opposite edges thereof (second embodiment), and an example in which each separator has support members provided in spots along two opposite edges thereof (third embodiment) are shown in the above embodiments, the support members are not limited to the above but may be in other forms in the present invention. For example, L-shaped support members may be formed at the corners of the separators, or support members may be formed in the shape of broken lines along the edges of the separators.

While the invention has been described with reference to what are considered to be example embodiments thereof, it is to be understood that the invention is not limited to the described embodiments or constructions. On the contrary, the invention is intended to cover various modifications and equivalent arrangements. In addition, while the various elements of the described invention are shown in various example combinations and configurations, other combinations and configurations, including more, less or only a single element, are also within the scope of the appended claims.

1-7. (canceled)

8. A fuel cell including a stack of unit cells each including an electrolyte membrane, a pair of electrodes disposed on both sides of the electrolyte membrane, and a pair of separators disposed outside the paired electrodes and in which a fastening load is applied in a stacking direction to maintain a stacked state of the stack, comprising:
through-holes formed through outer peripheral portions of the separators that allow at least a reactant gas or a fluid to flow through the separators;
receiving parts formed on the separators into which the electrolyte membrane and the pair of electrodes are fitted; and
seal members formed around the through-holes and around the receiving parts; wherein
additional support members are disposed between the pairs of separators for supporting the fastening load in areas with no through-holes for at least the reactant gas or the fluid on the outer peripheral portions of the separators.

9. The fuel cell according to claim 8, wherein the seal members are formed along at least part of the edges of the through-holes and the support members are formed integrally with the seal members.

10. The fuel cell according to claim 9, wherein the pairs of separators, the seal members, and the support members do not form an enclosed space.

11. The fuel cell according to claim 8, wherein the support members include adhesives.

12. The fuel cell according to claim 11, wherein the adhesive is a silicone, epoxy resin, epoxy-modified silicone, olefin, or olefin-modified silicone.

13. The fuel cell according to claim 8, wherein the support members include seal gaskets.

14. The fuel cell according to claim 8, wherein the support members have gas impermeability, elasticity, and heat resistance.
